(19) United States
(12) Patent Application Publication
(10) Pub. No.: US 2003/0222880 A1
(43) Pub. Date: Dec. 4, 2003

(54) Frame memory manager and method for a display system

(76) Inventor: John Karl Waterman, Mesa, AZ (US)

Correspondence Address: Bruce T. Neel, Esq., Gammage & Burnham PLC, 18th Floor, Two North Central, Phoenix, AZ, 85004, US

(21) Appl. No.: 10/158,479

(22) Filed: May 30, 2002

Related U.S. Application Data
(60) Provisional application No. 60/383,219, filed on May 24, 2002.

(51) Int. Cl. G09G 5/39; G06F 13/00; G09G 5/36

(52) U.S. Cl. 345/531; 345/558; 345/536

(57) ABSTRACT

A memory management circuit manages frame data for a display system such as used in a projection television system or cellular phone. The frame data includes frames corresponding to a series of images for viewing by a user. The memory manager includes an input buffer to receive the frame data, a memory interface coupled to receive the frame data from the input buffer, and an output buffer coupled to receive the frame data from the memory interface and output the frame data to a display such as a liquid crystal (LCD) micro-display. The memory interface sends and receives the frame data as packets, with each packet having a size less than a full frame, to and from an external memory able to store at least one full frame of data.

### RELATED APPLICATIONS

This application is a non-provisional application claiming benefit under 35 U.S.C. sec. 119(e) of U.S. Provisional Application Serial No. ______, filed May 24, 2002 (titled FRAME MEMORY MANAGER AND METHOD FOR A DISPLAY SYSTEM by John Karl Waterman, docket no. 4351-4PRV), which is incorporated by reference herein.

### BACKGROUND OF THE INVENTION

The present invention relates in general to display systems and, more specifically, to a system and method for the memory management of image data provided for display to a user in a display device such as, for example, a micro-display used for forming images in a projection television system.

Projection display systems, such as, for example, a projection television system, commonly use a light valve such as a liquid crystal display (LCD) to create images that are enlarged and projected onto a screen for viewing. Recently, reflective micro-displays have become increasingly popular as a preferred light valve for projection display applications. Typically, multiple micro-displays are used in a projection system, in many cases one for each of the primary colors of red, blue, and green. Other uses of micro-displays include direct viewers for personal computing devices such as cellular telephones and personal digital assistants (PDAs).

A projection display system using an LCD often is operated using frame inversion in which the polarity of the LCD is inverted for each successive frame so as to avoid physical degradation due to the inherent material properties of the liquid crystal material used in the LCD. When using frame inversion, frame doubling or tripling is desired to eliminate display flicker that may be visually perceived by a user of the system. The output frame rate typically needs to be at least about 100 Hz in order to eliminate such flicker.

One prior approach for frame doubling or tripling uses two separate memories in a ping/pong manner such that an entire first frame of video data is read, two or three times in succession for frame doubling or tripling, from the first memory for display while the entire next successive video frame is written to the second memory for display as the next frame after the first frame has been fully displayed. A limitation of this prior approach is that the quantity of memory required is larger due to the use of two full sets of memory, which increases the cost of manufacture and the size of the manufactured product.

In light of the foregoing, there is a need for an improved frame memory management system that reduces the manufacturing cost and size requirements that result from the use of separate memories for the reading and writing in a ping/pong manner of video data to be displayed in a display system.

### BRIEF DESCRIPTION OF THE DRAWINGS

For a more complete understanding of the present invention, reference is now made to the following figures, wherein like reference numbers refer to similar items throughout the figures:

FIG. 1 is a functional block diagram of a display system including a display;

FIG. 2 is a functional block diagram of a memory manager, in accordance with the teachings of the present invention, for managing frame data stored in a memory and driving the display of FIG. 1;

FIG. 3 is a graph illustrating the writing to and reading from the memory of FIG. 2 in accordance with a method of the present invention;

FIG. 4 is graph illustrating, in a more detailed view of a portion of the graph of FIG. 3, the writing to and reading from memory of individual frame data packets;

FIG. 5 is a graph illustrating the writing to and reading from the memory of FIG. 2 in accordance with an alternative method for the present invention using a rolling addressing scheme with frame doubling; and

FIG. 6 is a graph illustrating the writing to and reading from the memory of FIG. 2 in accordance with another embodiment of the alternative rolling addressing scheme using frame tripling.

### DETAILED DESCRIPTION OF THE DRAWINGS

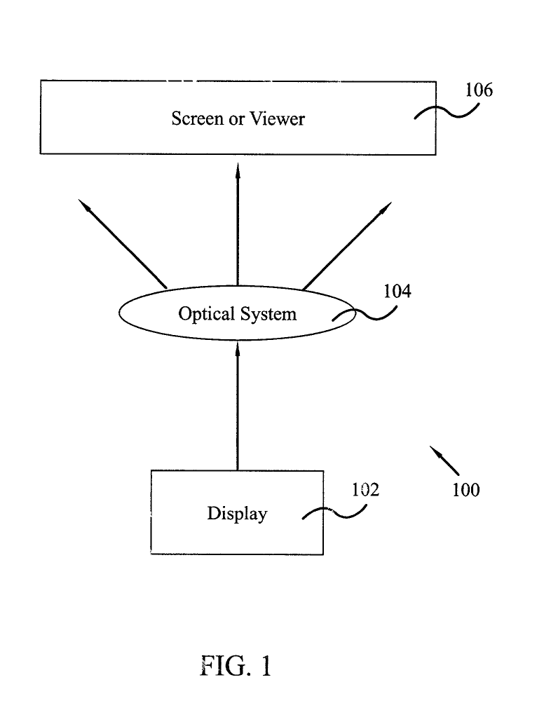

FIG. 1 is a functional block diagram of a display system 100 including a display 102 optically coupled to an optical system 104. Display 102 is, for example, an LCD micro-display used as a source of images to be displayed on a screen or viewer 106 through optical system 104. Display system 100 is, for example, a projection television system using a reflective micro-display. Display system 100 may also be other systems such as a high-resolution projector used for presentations or x-ray examination. In other embodiments, display system 100 may not include screen 106 so that a user either directly views images on display 102 or views display 102 with the assistance of some form of optical system 104, such as a lens that enlarges the images produced on display 102.

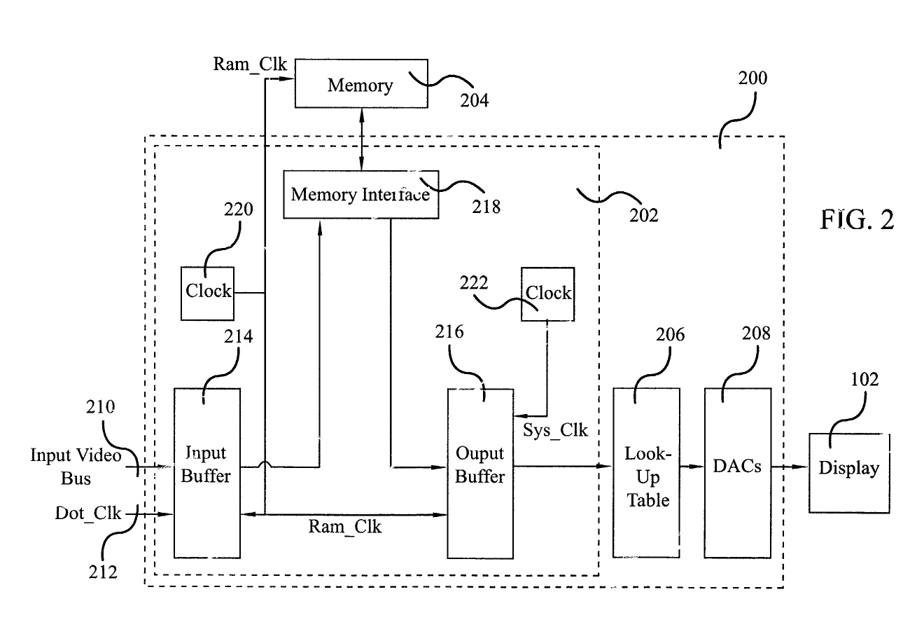

FIG. 2 is a functional block diagram of a driver circuit 200 coupled to display 102 and including a memory management circuit (or simply memory manager) 202, in accordance with the teachings of the present invention, for managing frame data stored in a memory 204. The frame data stored is, for example, conventional video frame data received by memory manager 202 at 60 Hz from an external source (not shown), such as, for example, a computer graphics card with a DVI digital output cable, on input video bus 210. Input video bus 210 may have, for example, six ports corresponding to even and odd red, green, and blue video signals in the form of digital grayscale representations. The frame data in general corresponds to series of images to be displayed to a user, and the present invention is intended to include applications for memory management in addition to video.

Memory manager 202 is coupled to memory 204 through a memory interface 218. Memory 204 is, for example, a dual data rate (DDR) synchronous dynamic random access memory (SDRAM), and memory interface 218 is, for example, a conventional DDR memory interface for reading and writing data to and from memory 204 in, for example, 2 or 4 byte-wide words, or other word sizes as may be desired for a specific application.

According to the present invention, memory manager 202 comprises an input buffer 214 coupled to provide frame data to memory interface 218, and an output buffer 216 coupled to receive frame data from memory interface 218. Input and output buffers 214 and 216 typically have wider bus widths than the bus size used for accessing memory 204 from memory interface 218, and the data exchange rate to and from memory 204 typically operates roughly 2, 3, 4 or more times faster than the frame data input rate to input buffer 214. As an example, input and output buffers 214 and 216 may be 12 bytes wide and one image line deep. However, it is not always necessary that the bus widths of input and output buffers 214 and 216 be wider than the bus size used for accessing memory 204. Generally, frame data is received by input buffer 214 at a rate of at least 20 full frames per second. However, in some cases frame data may be received at lower rates such as, for example, 8 frames per second.

Receipt of frame data by input buffer 214 on input video bus 210 is synchronized by a clock signal 212 (referred to herein as “Dot_Clk”). Dot_Clk may be provided by the external system (not shown) coupled to input video bus 210. Input and output buffers 214 and 216 may be implemented, for example, as first-in first-out memories (FIFOs). Input and output buffers 214 and 216 may also be implemented in other embodiments using registers, latches, or portions of a RAM.

The transfer of frame data between memory interface 218 and buffers 214 and 216 is synchronized by a clock signal Ram_Clk, which may be generated by a clock source 220. The transfer of frame data between memory interface 218 and memory 214 is also synchronized by Ram_Clk.

Output buffer 216 is coupled to provide frame data to a look-up table 206 as synchronized by a clock signal Sys Clk, which may be generated by a clock 222. By using separate clock signals Dot_Clk, Ram_Clk, and Sys_Clk, the Ram_Clk frequency can be optimized to meet necessary data transfer needs apart from the timing for the input and output buffer interfaces to the input video bus 210 and look-up table 206. Ram_Clk has, for example, a frequency of about 150 MHz or less (which corresponds to about 300 million clock edges per second for a DDR memory).

Look-up table 206 is coupled to an array of digital-to-analog converters (DACs) 208. DACs 208 convert digital frame data into analog form (for example, in 12 channels) for driving display 102. DACs 208 may be, for example, a set of 12 DACs operating in parallel corresponding to a 12-byte wide word size provided by output buffer 216. Look-up table 206 is, for example, an eo curve/gamma look-up table used to convert 8-bit digital video data (in grayscale space) into an 11-bit precision voltage form in preparation for signal conversion in DACs 208. In other embodiments, DACs 208 may be coupled to more than one display 102, such as for example three displays (for each of the primary colors red, green, and blue).

According to the present invention, memory manager 202 handles frame data in terms of packets, each of which has a size less than a full frame and more typically corresponding to only one or a few lines of the displayed image. A packet of data corresponding to a line or row of the image to be displayed may typically contain several thousand bytes of data. Frame data is substantially simultaneously written to and read from a single memory 204, as contrasted with prior approaches using two or more separate memories, as described below by reading and writing frame data in terms of packets. Memory manager 202 comprises firmware (not shown) for controlling the operation of memory manager 202. Memory 204 has a size, for example, to store at least one and a half full frames of image data, and more typically at least two full frames of image data.

Frame data is latched by input buffer 214 as packets of frame data, which are provided to memory interface 218 for storage in memory 204. Output buffer 216 receives frame data from memory 204 through memory interface 218 in packets as described above. Each packet is in general less than a full or entire frame and is, for example, an amount of frame data that corresponds to about one line or row of the image for the entire frame that is to be displayed on display 102 or screen 106. Packet sizes of less than about 5 lines, or another selected small number of lines, or even less than a single line (for example, a half line) may also be used. Generally, it is preferred that packet sizes be less than about twenty percent of the total size of an entire frame of video data. A typical frame size is, for example, about one to ten million bytes.

It should be noted that memory interface 218 parses frame data into and out of memory 204 generally using only packets of frame data, in contrast with the transferring of data for a full frame, as is further described below. For example, when using frame doubling, a packet is read twice from memory 204 for each packet written to memory 204. When using frame tripling, a packet is read three times for each packet written. Frame multiplying may include even greater multiples such as, for example, reading a packet fifteen times for each packet written. It should also be noted that frame multiplying approaches need not be used with the present invention, and a single frame can be output to display 102 for each frame input to input buffer 214.

The size of input buffer 214 and output buffer 216 generally corresponds to the packet size selected, and typically buffers 214 and 216 should be slightly larger than the selected packet size. For example, for a typical expected worst case simulation for a single driver circuit 200 driving three displays 102 (one for each color of red, green, and blue) and with each display having a resolution of 1280×720 pixels, it was determined that input and output buffers 214 and 216 should have a storage size of about 50% larger than the packet size (for example, a packet size in this case of 1280 pixels×3 colors=3840 bytes) selected for use. Typically, input and output buffers 214 and 216 each has a size to store data for no more than five times the packet size (e.g., for the case of a packet size of one line, no more than five lines or rows of an image).

Input buffer 214 stores a packet until memory interface 218 is ready to start writing the packet into memory 204. For the case of frame doubling, the burst write from input buffer 214 must be active no more than one-third of the time, and the burst read to output buffer 216 from memory 204 must be active for no more than two-thirds of the time.

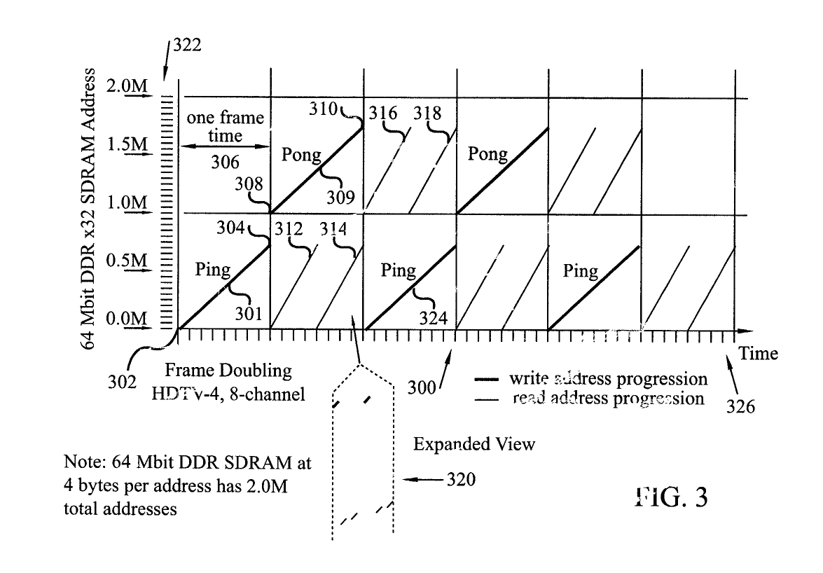

FIG. 3 is a graph 300 illustrating the writing to and reading from memory 204 in accordance with a method of the present invention. The vertical axis of graph 300 shows the address space 322 for memory 204, and the horizontal axis corresponds to time 326. For the specific example illustrated in FIG. 3, memory 204 is a 64 megabit DDR SDRAM storing 4 bytes per address for a total of 2.0 million (2.0M) address locations, as indicated on the vertical axis. The application illustrated is for a frame doubling display system. Also, display 102 has in this example a resolution of 1280×768 pixels with each frame occupying 2.81 Mbytes of the 8 Mbyte memory 204.

Address space 322 is partitioned into two portions in this example (one portion indicated by “PING” and the other portion by “PONG”). In this embodiment, each portion has a size of 1.0M address locations. The data for a first full frame 301 of video data is shown being stored in memory 204 between an initial address location 302 and an ending address location 304. The data for a second full frame 309 of video data is shown being stored in memory 204 between an initial address location 308 and an ending address location 310.

Frame 301 is written to memory 204 during a time period indicated as frame time period 306 in FIG. 3. Each of the subsequent written frames is written in a substantially similar time period. It should be noted that the address space of memory 204 is contiguously and continually incremented for the entire frame so that the full transfer rate of the DDR memory can be achieved, with a data packet preferably being written on each rising and falling edge of Ram_Clk.

As mentioned above, frame 301 is written to memory 204 in first time period 306, and for this example of frame doubling, is read two times from memory 204 in the next subsequent frame time period as indicated by lines 312 and 314. While frame 301 is being read two times in the next frame time period, frame 309 is being written to memory 204 between address locations 308 and 310.

Similarly as for frame 301, frame 309 is read two times as indicated by lines 316 and 318 during the same frame time period as the next frame 324 is written to the PING portion of memory. It should be noted that in general two PING frames are read from memory 204 during substantially the same frame time period as one PONG frame is written to memory 204, or two PONG frames are read from memory 204 during substantially the same frame time period as one PING frame is written to memory 204.

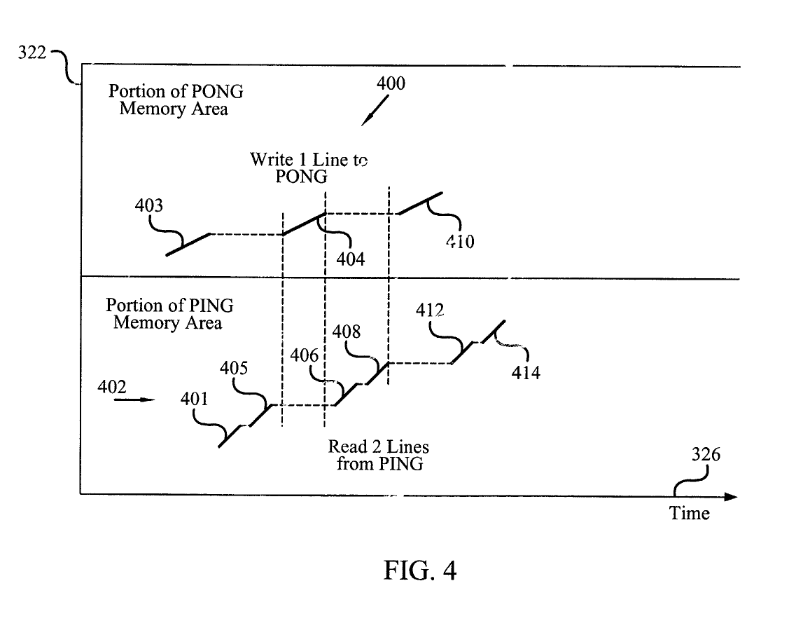

It is important to note that FIG. 3 is a simplified representation for purposes of illustration. In actuality, packets of frame data for PING and PONG portions of memory 204 are repeatedly and alternately written to and read from memory 204 as was described above (for example, 5, 10, 100, or more times per frame). Expanded view 320 (also see FIG. 4) shows in more detail a portion of written frame 309 and read frame 314 and indicates with broken lines the alternating aspect of this reading and writing.

FIG. 4 is graph illustrating, in a more detailed view of expanded view 320 of graph 300 of FIG. 3, the writing to and reading from memory 204 of individual frame data packets. A portion 400 of the PONG memory area and a portion 402 of the PING memory area of address space 322 are illustrated. In this specific illustrated example a packet size is one line or row of video data in the image corresponding to a full frame of image data. Packets 403, 404, and 410 correspond to a portion of line 309 shown in FIG. 3, and as described above and according to the present invention, FIG. 4 illustrates that writing to memory 204 is done in a plurality of bursts of packets (in this case single lines). Also, according to the present invention, packets 401, 405, 406, 408, 412, and 414 correspond to a portion of line 314 shown in FIG. 3 and illustrate that reading from memory 204 is done in a plurality of bursts of packets from the PING memory area in an alternating manner with the writing of packets to the PONG memory area.

For the case of frame doubling as shown in FIG. 4, two packets 406 and 408 are read after one packet 404 is written, and this alternating pattern is continued. For frame tripling, three packets would be read from the PING memory areas for each one packet written to the PONG memory area.

As an example of the system clock frequencies that may be used for a specific embodiment of driver circuit 200, for the case of an SXGA format, with a 56 MHz Dot_Clk signal, a 43 MHz Sys_Clk signal, and 2:1 frame buffering, a rough estimate of the Ram_Clk frequency is determined as follows:

1. The input buffer 214 width receives data every Dot_Clk cycle (3 even pixels and 3 odd pixels per Dot_Clk cycle). At this rate, to receive a 1280 pixel three-color line takes about 1280×(3 colors)/6/56 MHz=11.5 microseconds (for about 20% horizontal blanking, on average a line is received every 11.5×1.2=15 microseconds).

2. The output buffer 216 width provides output every Sys_Clk cycle and should output 2 lines in about the same time period as calculated above: 1280×(3 colors)×(2 lines)/12/43 MHz=15 microseconds.

3. During this same 15 microsecond time period, memory 204 must provide sufficient input/output access by storing 1 line and retreiving 2 lines for a total of 3 lines: 1280×(3 colors)×(3 lines)/4/(Ram_Clk frequency)=15 microseconds, so Ram_Clk frequency is about 192M edges per second. The actual Ram_Clk signal uses both edges in the example of a DDR SDRAM, which corresponds to a Ram_Clk frequency of 96 MHz.

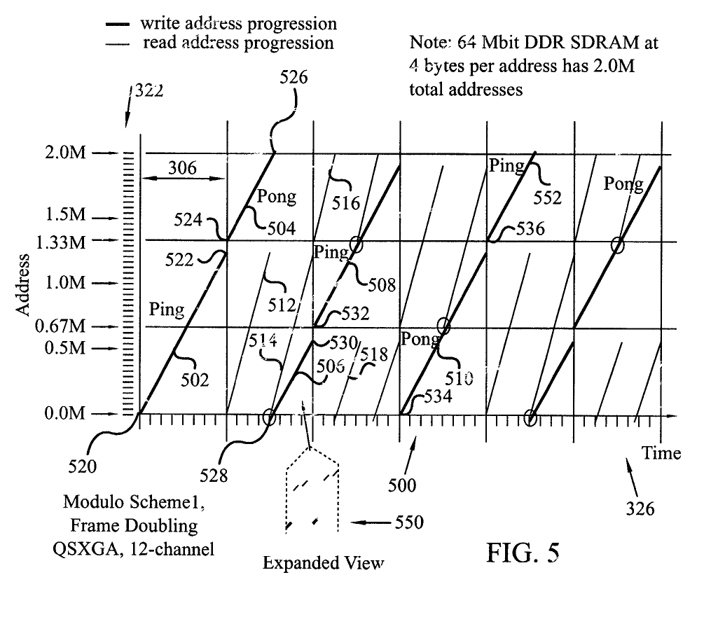

FIG. 5 is a graph 500 illustrating the writing to and reading from memory 204 in accordance with an alternative method for the present invention using a rolling or modulo addressing scheme. The vertical axis of graph 300 shows the address space 322 for memory 204, and the horizontal axis corresponds to time 326. The use of this alternative method permits the management in memory 204 of two frames by memory manager 202 even though an entire single frame occupies more than 50% of the total memory space available in memory 204. According to this method, the quantity of memory required in a manufactured memory manager product can be reduced relative to use of a memory with fixed starting address locations as illustrated in FIG. 3 above.

For the specific example illustrated in FIG. 5, as for FIG. 3 above, memory 204 is a 64 megabit DDR SDRAM storing 4 bytes per address for a total of 2.0M address locations. The application illustrated is for a frame doubling display system. In this example, display 102 is operated to conform to the QSXGA monochrome video format and has a resolution of 2560×2048 pixels with each frame occupying 5.0 Mbytes of the 8 Mbyte memory 204. All frames are written to or read from memory 204 with contiguous address incrementing as described above for FIG. 3.

In this rolling addressing scheme, the starting address location for PING and PONG frames varies in a repetitive manner through a defined fixed set of starting address locations. For example, for the case shown in FIG. 5, there are three starting address locations 520, 524, and 532. It can be seen that PING frame 502 is written in frame time period 306 using starting address location 520, PONG frame 504 (which extends as line 506 as discussed below) is next written using starting address location 524, and then the next PING frame 508 is written using starting address location 532.

The cycle of rolling or rotating through the above set of starting address locations repeats with the writing of PONG frame 510 using starting address location 534, which is the same starting address location as location 520. The next PING frame 552 is written using starting address location 536, which is the same starting location as location 524. This cycle generally continues to repeat during the operation of memory manager 202.

Now more specifically describing FIG. 5, PING frame 502 is read (at the time and from the address locations indicated by lines 512 and 514) in the next frame time period after writing PING frame 502. Note that frame 502 is read two times in substantially the same frame time period as PONG frame 504 is written.

PING frame 502 has an ending address location 522. PONG frame 504 is written in the upper portions of address space 322 until the upper limit of the address space is reached at point 526. The contiguous writing of the remainder portion 506 of PONG frame 504 is continued starting from address location 528, the lower limit of address space 322 (which is indicated by reference number 520), and continuing to the ending address location 530 for this PONG frame.

It should be noted that portion 506 of PONG frame 504 is in a common or shared portion of address space 322 that was earlier used for storing PING frame 502. A collision between PING and PONG frames is avoided, however, because PING frame 502 is read from memory 204 at lines 512 and 514, and thus no longer needs to be accessed again by driver circuit 200, prior to writing PONG frame portion 506. The shared portion of address space 322 will vary from frame to frame as time 326 progresses and the starting address locations are cycled.

Similarly, PONG frame 504 is read two times prior to writing the final portion of PING frame 508 so that a frame collision is again avoided. The first reading of PONG frame 504 is done at the time indicated by lines 516 and 518. Line 518 corresponds to written portion 506 of the PONG frame, which is stored in the lower address space of memory 204.

The theoretical maximum frame size that can be used for the example of FIG. 5 is about 5.33 Mbytes. Thus, FIG. 5 illustrates a situation in which frame collision in narrowly avoided. Typically, an actual implementation should provide more margin than that illustrated here.

As described above for FIG. 3, FIG. 5 is also simplified for purposes of illustration. Packets of frame data for PING and PONG frames stored in memory 204 using the above rolling addressing scheme are repeatedly and alternately written to and read from memory 204 substantially as was described above in detail for FIG. 4. Expanded view 550 shows in more detail a portion of written PONG frame portion 506 and the reading of PING frame 514 (indicating with broken lines the alternating aspect of this reading and writing). For the frame doubling shown here, two packets are read alternately with the writing of one packet, with each packet being of a size, for example, of one display or image row or line. In other applications, the portions of PING and PONG frames alternately written and read may differ and be one, two, three or another number of packets.

More detailed information about the starting address locations for PING and PONG frames in FIG. 5 is presented in the following table:

| | |
|---|---|
| Address 0 for PING | |
| Address 1.33 M for PONG | (during a write or read, the address hits 2 M |
| | then continues at address 0) |
| Address 0.67 M for PING | |
| Address 0 for PONG | |
| Address 1.33 M for PING | (during a write or read, the address hits 2 M |
| | then continues at address 0) |
| Address 0.67 M for PONG | |
| Address 0 for PING | (the process then repeats) |

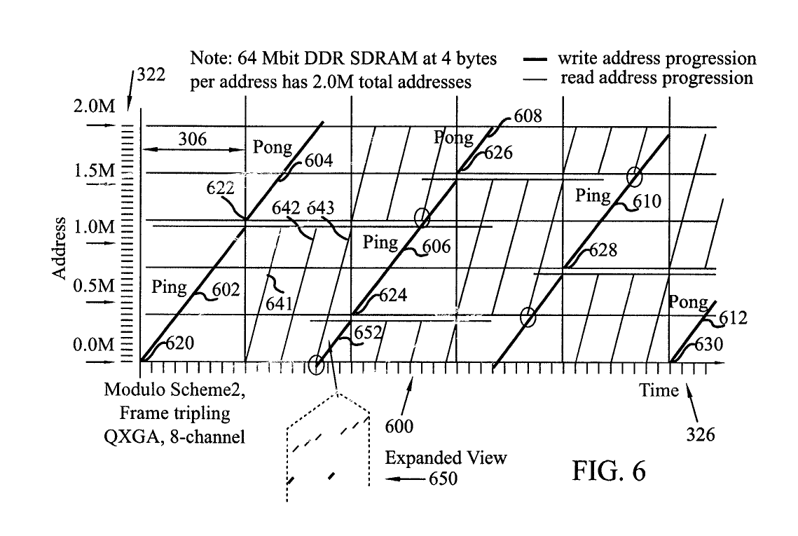

FIG. 6 is a graph 600 illustrating the writing to and reading from memory 204 in accordance with another embodiment of the alternative rolling address scheme using frame tripling. For the specific example illustrated in FIG. 6, as for FIGS. 3 and 5 above, memory 204 is a 64 megabit (or 8 Mbyte) DDR SDRAM storing 4 bytes per address location for a total of 2.0M address locations (indicated as address space 322). Frame tripling is used, and display 102 is operated to conform to the QXGA video format (for one and a half colors such as where one driver circuit handles a full frame for one color and half of a full frame for a second color) having a resolution of 2048×1536 pixels with each of two PING and PONG frames occupying 4.5 Mbytes of the 8 Mbyte total memory space. In this example, another set of drive electronics (not shown) would be used to drive another one and a half colors to provide a total of three colors. All frames are written to and read from memory 204 with contiguous address incrementing as described above for FIG. 3. This example illustrates an application near the theoretical maximum frame size of 4.8 Mbytes/frame. In an actual application, it would be preferred to use a smaller frame size to provide a greater collision margin.

Similarly as described above for FIG. 5, a set of fixed starting address locations is cycled or rolled through in order during operation of memory manager 202. Here, there are five starting address locations 620, 622, 624, 626, and 628 in the defined set to be cycled through.

In operation, PING frame 602 is written to memory 204 starting with location 620, then PONG frame 604 is written starting at location 622, then PING frame 606 is written starting at location 624, then PONG frame 608 is written starting at location 626, and then PING frame 610 is written starting at location 628. This cycle starts to repeat with the writing of PONG frame 612 starting at location 630.

Frame tripling is accomplished by the reading of each frame three times from memory 204 as indicated by lines 641, 642, and 643. It should be noted that the rolling address scheme of FIG. 6 could also be used with frame doubling instead of frame tripling as shown here.

Similarly as discussed above for FIGS. 3 and 5, FIG. 6 is a simplified representation. Expanded view 650 shows a detailed view of a portion of read frame 643 and written frame portion 652. Here, the alternating reading and writing of frame data packets is similar to that shown in FIG. 4 except that three packets of frame data are read in an alternating manner with each packet of frame data written to memory 204.

More detailed information about the starting address locations for PING and PONG frames in FIG. 6 is presented in the following table:

| | |
|---|---|
| Address 0 for PING | |
| Address 1.2 M for PONG | (during a write or read, the address hits 2 M |
| | then continues at address 0) |
| Address 0.4 M for PING | |
| Address 1.6 M for PONG | (during a write or read, the address hits 2 M |
| | then continues at address 0) |
| Address 0.8 M for PING | |
| Address 0 for PONG | |
| Address 1.2 M for PING | (during a write or read, the address hits 2 M |
| | then continues at address 0) |
| Address 0.4 M for PONG | |
| Address 1.6 M for PING | (during a write or read, the address hits 2 M |
| | then continues at address 0) |
| Address 0.8 M for PONG | |
| Address 0 for PING | (the process then repeats) |

In addition to the use of three or five starting address locations, which are common to each of the PING and PONG frame sets, as shown above, in other embodiments of the present invention a different number of fixed starting address locations could be selected for the set of locations that is cycled through during use of the rolling address scheme. Also, in certain applications, the actual address locations and the number of such locations might be varied from time to time under the control of memory manager 202 or by an external circuit (not shown).

By the foregoing description, a novel method and system for the memory management of frame data for use in a display system have been described. The present invention has the advantages of reducing the manufacturing cost and size requirements for the memory used to store frame data to be displayed in a display system. Another advantage is that the memory size can be effectively increased by about 33% using the rolling addressing scheme described above.

Although specific embodiments have been described above, it will be appreciated that numerous modifications and substitutions of the invention may be made. For example, in addition to projection television systems, the present invention may also be used in office projectors, monitors for computer systems, digital photographic development, optical data storage, and high-resolution x-ray projector and display systems. The present invention may further be used in systems that display still images. Accordingly, the invention has been described by way of illustration rather than limitation.

What is claimed is:

1. A memory manager to manage frame data for a display system, wherein the frame data comprises a frame corresponding to an image, the memory manager comprising:
an input buffer to receive the frame data;
a memory interface coupled to receive the frame data from the input buffer;
an output buffer coupled to receive the frame data from the memory interface and output the frame data; and
wherein the memory interface is operable to send and receive the frame data, as a plurality of packets with each packet having a size less than a full frame, to and from a memory operable to store the frame data.

2. The memory manager of claim 1 wherein the frame data is received by the input buffer at a rate of at least 20 full frames per second.

3. The memory manager of claim 1 wherein the image is a still image.

4. The memory manager of claim 1 wherein the size of each packet is less than about 20 percent of the total size for the full frame.

5. The memory manager of claim 1 wherein the size of each packet is less than five lines in the image.

6. The memory manager of claim 1 wherein the size of each packet is about one line in the image.

7. The memory manager of claim 1 wherein the frame data is frames of video data.

8. The memory manager of claim 1 wherein the memory is operable to store at least one and a half full frames of data.

9. The memory manager of claim 1 wherein the memory is operable to store at least two full frames of data.

10. The memory manager of claim 8 wherein:
the image is a first image of a series of images and the frame corresponding to the image is a first frame;
the frame data comprises a second frame corresponding to a second image of the series of images; and
the memory interface is further operable to alternately read a first portion of the first frame from the memory and write a first portion of the second frame to the memory.

11. The memory manager of claim 10 wherein the first portion of the first frame comprises two packets of data.

12. The memory manager of claim 11 wherein each of the two packets of data corresponds to a single line in the first image.

13. The memory manager of claim 11 wherein the first portion of the second frame corresponds to one packet of data.

14. The memory manager of claim 13 wherein the one packet of data corresponds to a single line in the second image.

15. The memory manager of claim 10 wherein the first portion of the first frame comprises three packets of data.

16. The memory manager of claim 15 wherein each of the three packets of data corresponds to a single line in the first image.

17. The memory manager of claim 10 wherein the memory interface is further operable to read a second portion of the first frame from the memory after writing the first portion of the second frame.

18. The memory manager of claim 1 wherein:
the image is a first image of a series of images and the frame corresponding to the image is a first frame;
the frame data comprises a second frame corresponding to a second image of the series of images; and
the memory interface is further operable to read the full first frame from the memory at least two times substantially during the same time period corresponding to writing the full second frame to the memory.

19. The memory manager of claim 1 wherein the output buffer is coupled to provide the frame data to a display for generating the image.

20. The memory manager of claim 1 wherein the input buffer is a first-in first-out (FIFO) memory.

21. The memory manager of claim 20 wherein the output buffer is a first-in first-out (FIFO) memory.

22. The memory manager of claim 1 wherein the input buffer is operable to store no more than five lines of the image.

23. The memory manager of claim 22 wherein the output buffer is operable to store no more than five lines of the image.

24. The memory manager of claim 1 wherein:
the smallest packet of the plurality of packets has a packet size; and
the input buffer is operable to store no more data than five times the packet size.

25. The memory manager of claim 1 wherein:
the smallest packet of the plurality of packets has a packet size; and
the input buffer is operable to store no more data than about one and a half times the packet size.

26. The memory manager of claim 1 wherein timing of the transfer of the plurality of packets between the input buffer, memory, and output buffer is controlled by a first clock.

27. The memory manager of claim 26 wherein timing of the receiving of the frame data by the input buffer is controlled by a second clock that is independent of the first clock.

28. The memory manager of claim 27 wherein timing of the outputting of the frame data by the output buffer is controlled by a third clock that is independent of the first clock and second clock.

29. The memory manager of claim 1 wherein:
the output buffer is coupled to a look-up table;
the look-up table is coupled to provide the frame data to a plurality of digital-to-analog converters (DACs); and
the plurality of DACs is coupled to provide the frame data to a display for generating the image.

30. The memory manager of claim 1 wherein the memory is a dual data rate synchronous dynamic random access memory.

31. The memory manager of claim 1 wherein the memory interface addresses the memory in an always increasing incremental manner of memory addressing during the reading or writing of data at least until a frame has been fully read or written.

32. A display system to manage data, wherein the data comprises a plurality of frames with each frame corresponding to one of a plurality of images, the display system comprising:
an input buffer to receive the data as a plurality of packets;
a memory interface coupled to receive the plurality of packets from the input buffer;
an output buffer coupled to receive the plurality of packets from the memory interface and output the plurality of packets; and
wherein the memory interface is operable to read and write the data to and from a memory as a plurality of packets with each packet having a size less than a full frame, the memory being operable to store at least one and a half full frames.

33. The display system of claim 32 wherein the memory interface is operable to alternately read and write the plurality of packets, for at least five total packets read and at least five total packets written for a single frame, in less time than required for the output buffer to output a full frame.

34. The display system of claim 33 wherein each of the plurality of packets has the size of about a video line of data.

35. A display system comprising:
a screen for a user to view images;
a display to generate the images;
an optical system coupling the display to the screen;
a memory manager, wherein the memory manager comprises:
(i) an input buffer to receive frame data corresponding to the images; and
(ii) an output buffer to provide the frame data to the display; and
a memory coupled to receive the frame data from the input buffer and to provide the frame data to the output buffer, wherein:
(i) the frame data comprises data for a first frame and a second frame;
(ii) a first portion of the first frame is stored in the memory; and
(iii) a first portion of the second frame is read from the memory after storing the first portion of the first frame in the memory; and
(iv) a second portion of the first frame is stored in the memory after reading the first portion of the second frame from the memory.

36. The display system of claim 35 wherein the display system is a projection television system.

37. The display system of claim 35 wh ere in the memory is a random access memory.

38. The display system of claim 35 wherein the display system is selected from the group consisting of: a projector, a personal computer monitor, a digital photographic development system, an optical data storage system, and an x-ray projector/display system.

39. A display system comprising:
a display for a user to view images;
a display coupled to receive frame data to form the images;
a memory manager, wherein the memory manager comprises:
(i) an input buffer to receive the frame data;
(ii) an output buffer to provide the frame data to the display; and
a memory coupled to receive the frame data from the input buffer and to provide the frame data to the output buffer, wherein:
(i) the frame data comprises data for a first frame and a second frame;
(ii) a first portion of the first frame is stored in the memory; and
(iii) a first portion of the second frame is read from the memory after storing the first portion of the first frame in the memory; and
(iv) a second portion of the first frame is stored in the memory after reading the first portion of the second frame from the memory.

40. The display system of claim 39 wherein the display system is a cellular phone.

41. The display system of claim 39 wherein the display system is a portable computing device.

42. A method of managing frame data for use in a display system, wherein the frame data comprises a first frame and a second frame, the method comprising:
(a) reading a first portion of a first frame from a memory operable to store at least one full frame of the frame data;
(b) after reading the first portion of the first frame, writing a first portion of the second frame to the memory; and
(c) after writing the first portion of the second frame to the memory, reading a second portion of the first frame from the memory.

43. The method of claim 42 further comprising alternately repeating items (a) and (b) each at least ten times, for additional portions of the first frame and the second frame, prior to writing the entire second frame to the memory.

44. The method of claim 42 further comprising:
writing the entire second frame to the memory in a time period; and
reading the entire first frame at least two times from the memory substantially during same time period.

45. The method of claim 42 wherein:
the memory is partitioned into a first partition and a second partition;
the first frame is stored fully within the first partition; and
the second frame is stored fully within the second partition.

46. The method of claim 45 wherein:
the first frame is accessed in the memory using a plurality of memory addresses; and
the first frame is read from the memory by continuously incrementing or decrementing through the plurality of memory addresses.

47. The method of claim 46 wherein the plurality of memory addresses comprises a starting address and an ending address for the first frame.

48. The method of claim 47 wherein the starting address and the ending address are within the address space of the first partition.

49. A computer-readable medium having computer-executable instructions for performing the method of claim 42.

50. The computer-readable medium of claim 49 wherein the computer-readable medium is selected from the group consisting of: a floppy disk, a hard drive, a CD-ROM, and a RAM.

51. A method of managing frame data for use in a display system, wherein the frame data comprises a first frame, a second frame, a third frame, and a fourth frame, the method comprising:
writing the first frame to a memory operable to store at least one full frame, but less than two full frames, of the frame data, wherein the first frame is stored in the memory starting at a first starting address;
writing the second frame to the memory, wherein the second frame is the next frame written to the memory after the first frame and is stored in the memory starting at a second starting address different from the first starting address;
writing the third frame to the memory, wherein the third frame is the next frame written to the memory after the second frame and is stored in the memory starting at a third starting address different from the first and second starting addresses; and
writing the fourth frame to the memory, wherein the fourth frame is the next frame written to the memory after the third frame and is stored in the memory starting at the first starting address.

52. A method of storing frame data for use in a display system, the method comprising consecutively writing a plurality of frames, corresponding to a series of images for display to a user, to a memory wherein the memory address space of the memory used to write a first frame of the plurality of frames is common with at least a portion of the memory address space used to write a second frame of the plurality of frames.

53. The method of claim 52 wherein:
starting addresses for writing each of the plurality of frames in the memory repeatedly cycle through at least first, second, and third address locations; and
the first, second, and third address locations are different.

54. The method of claim 52 further comprising consecutively reading the plurality of frames from the memory wherein starting addresses for reading each of the plurality of frames repeatedly cycle through the same at least first, second, and third address locations.

55. The method of claim 52 wherein reading a portion of the first frame from the memory and alternately writing a portion of the second frame to the memory are continuously repeated.

56. The method of claim 52 wherein each of the plurality of frames is written to the memory by incrementing or decrementing the memory address throughout the full storage location of each frame in the memory.

57. A method of storing frame data for use in a display system, the method comprising consecutively writing a plurality of frames, corresponding to a plurality of images for display to a user, to a memory wherein:
starting addresses for writing each of the plurality of frames in the memory repeatedly cycle through at least first, second, and third address locations; and
the first, second, and third address locations are different.

58. The method of claim 57 wherein the starting addresses repeatedly cycle through five different address locations.

59. The method of claim 58 wherein the memory is operable to store at least one full frame, but less than two full frames, of the frame data.

60. The method of claim 57 wherein the plurality of images are displayed to the user at a frequency of at least about 60 images per second.

61. A memory manager to manage frame data for a display system, wherein the frame data comprises a first frame corresponding to a first image of a series of video images, the memory manager comprising:
an input buffer to receive the frame data;
a memory interface coupled to receive the frame data from the input buffer;
an output buffer coupled to receive the frame data from the memory interface and output the frame data;
wherein the memory interface is operable to send and receive the frame data, as a plurality of packets with each packet having a size less than a full frame, to and from a memory operable to store the frame data;
wherein the size of each packet is less than about 20 percent of the total full frame size; and
wherein the memory is operable to store at least one and a half full frames of video data.

62. The memory manager of claim 61 wherein the memory is operable to store at least two full frames of data.

63. The memory manager of claim 61 wherein:
the frame data comprises a second frame corresponding to a second image of the series of images; and
the memory interface is further operable to alternately read a portion of the first frame from the memory and write a portion of the second frame to the memory.

64. The memory manager of claim 63 wherein:
each of the plurality of packets has a packet size; and
the input buffer is operable to store no more data than five times the packet size.

65. The memory manager of claim 64 wherein:
the output buffer is coupled to a look-up table;
the look-up table is coupled to provide the frame data to a plurality of digital-to-analog converters (DACs); and
the plurality of DACs is coupled to provide the frame data to a display for generating the series of images.

66. The memory manager of claim 61 wherein the frame data is received by the input buffer at a rate of at least 20 full frames per second.
